(19) United States
(12) Patent Application Publication
(10) Pub. No.: US 2022/0083032 A1
(43) Pub. Date: Mar. 17, 2022

(54) SMART FACTORY MONITORING SYSTEM

(71) Applicant: NEO SEMITECH CO., LTD, Cheongju-si, Changcheongbuk-do (KR)

(72) Inventors: Sun Kak KIM, Cheongju-si, Chungcheongbuk-do (KR); Sang Hun HONG, Cheongju-si, Chungcheongbuk-do (KR)

(21) Appl. No.: 17/419,894

(22) PCT Filed: Jul. 25, 2019
(86) PCT No.: PCT/KR2019/009262

§ 371 Date: Jun. 30, 2021

(30) Foreign Application Priority Data
Dec. 31, 2018 (KR) 10-2018-0173664

(51) Int. Cl. G05B 19/418

(52) U.S. Cl. CPC G05B 19/41865; G05B 2219/37533

(57) ABSTRACT

A smart factory monitoring system of the present disclosure includes a sensor module including a plurality of sensors mounted on various facilities of a factory to detect different physical properties and converting communication protocols of a plurality of sensor data into an integrated protocol, an integrated management module integrating and managing data measured by the sensor including the plurality of sensor modules through a pattern or trend analysis, a management server backing up and managing data on the pattern or trend analyzed by the integrated management module and providing the data according to a request of an external device, and a manager terminal connected to the integrated management module or the management server to perform monitoring at a remote location. Accordingly, it is possible more accurately to detect abnormal signals of equipment through trend analysis or pattern analysis for data measured by each sensor.

### TECHNICAL FIELD

The present disclosure relates to a smart factory monitoring system, and more particularly, a smart factory monitoring system which attaches various types of sensors using different communication protocols to each of various equipment installed in a factory, converts the communication protocol of sensor data detected by the sensor into an integrated protocol to perform analysis, determines abnormal signs of each facility environment based on the analysis results, and detects abnormal signs of equipment through trend analysis or pattern analysis of each sensor.

### BACKGROUND ART

With development of an information & communication technology (ICT), in recent years, transition to a smart factory is in progress so that factories are operated more efficiently by replacing tasks that cannot be performed by manpower or tasks performed by manpower in conventional factories with various sensors or the like.

For example, facilities management technologies based on a ubiquitous sensor network (USN) or a wireless sensor network system are being popularized in order to protect facilities at industrial sites and to protect workers at facility sites.

The wireless sensor network system includes a plurality of sensors that generate sensor data by detecting a facility state or a facility environment, and a remote control device that remotely monitors the facility based on the sensor data.

Meanwhile, recently released sensors capable of measuring indoor/outdoor environment-related factors are independent modules, and interfaces of data output from each sensor are different.

For this reason, in order to collect various types of environmental data, it is inevitable to use various modules suitable for a sensing device, and thus, there are problems in that costs increase and it takes a lot of time to optimize integration of the sensor modules.

In addition, since a circuit is designed so that the existing sensor device can communicate only with the target of a specific facility, in this case, when an object to be controlled and measured is added, there is a problem in that the sensor device should be redesigned and developed to suit the added objects.

In addition, even when sensed data is transmitted to a device located in a short distance, disconnection occurs frequently due to external interference, and thus, it is difficult to transmit data in real time.

In addition, a sensor communicates with a remote control system through a relay node. However, when the relay node does not operate normally due to obsolescence or failure of the relay node, there is a problem in that communication with the sensor device belonging to the relay node is interrupted.

Accordingly, there is a need to develop a technology capable of converting and providing sensing data of sensors having different communication protocols into one communication protocol, and managing an environment or facilities of an industrial site in an integrated manner through the sensing data.

In addition, it is necessary to more accurately determine abnormal signs through trend analysis and pattern analysis according to characteristics of physical property values detected by the sensor.

### DISCLOSURE

### Technical Problem

According to the above-described problems and needs, the present disclosure is directed to providing a smart factory monitoring system which attaches various types of sensors using different communication protocols to each of various equipment installed in a factory, converts the communication protocol of sensor data detected by the sensor into an integrated protocol to perform analysis, determines abnormal signs of each facility environment based on the analysis results, and detects abnormal signs of equipment through trend analysis or pattern analysis of each sensor.

### Technical Solution

According to an aspect of the present disclosure, there is provided a smart factory monitoring system including: a sensor module including a plurality of sensors mounted on various facilities of a factory to detect different physical properties and converting communication protocols of a plurality of sensor data into an integrated protocol; an integrated management module integrating and managing data measured by the sensor including the plurality of sensor modules through a pattern or trend analysis; a management server backing up and managing data on the pattern or trend analyzed by the integrated management module and providing the data according to a request of an external device; and a manager terminal connected to the integrated management module or the management server to perform monitoring at a remote location.

In the smart factory monitoring system of the present disclosure for achieving the above-described object, the integrated management module may include: a sensor management unit registering and managing the sensor or sensor module; a communication unit receiving sensor data from the sensor or sensor module or transmitting analyzed data to the management server or manager terminal; an output unit outputting an abnormality to a facility to which the sensor or sensor module is attached through any one of a text, video, sound, lamp, and fire extinguisher operation when the abnormality is detected according to the sensor data by the sensor or sensor module; a database unit converting data detected by the sensor or sensor module into a database to manage and store the database; a pattern analysis unit comparing and analyzing the data measured by the sensor or sensor module and data stored according to a pattern of the database unit; a trend analysis unit comparing and analyzing the data measured by the sensor or sensor module and data stored according to a trend of the database unit; and a main control unit controlling an operation of equipment to which the sensor or sensor module is attached when the pattern by the pattern analysis unit is deviated from the trend by the trend analysis unit.

In the smart factory monitoring system of the present disclosure for achieving the above-described object, the database unit may include: a pattern DB in which a time variable is combined to a measurement value measured by the sensor or sensor module and a distribution of the measurement values is stored at a specific period; and a trend DB in which only the distribution of the measurement values measured by the sensor or sensor module is stored.

In the smart factory monitoring system of the present disclosure for achieving the above-described object, the main control unit may output a signal of any one of waring, alarm, and operation stopping of equipment according to a concordance ratio between the value measured by the sensor or sensor module and a pattern data value stored in the pattern DB, as a result of the pattern analysis of the pattern analysis unit.

In the smart factory monitoring system of the present disclosure for achieving the above-described object, the main control unit may output the signal of any one of the waring, alarm, and operation stopping of the equipment according to a concordance ratio between the value measured by the sensor or sensor module and a trend data value stored in the trend DB, as a result of the trend analysis of the trend analysis unit.

### Advantageous Effects

According to the smart factory monitoring system according to the present disclosure, it is possible more accurately to detect abnormal signals of equipment through trend analysis or pattern analysis for data measured by each sensor.

### DESCRIPTION OF DRAWINGS

FIG. 1 is a conceptual diagram illustrating a smart factory monitoring system according to one embodiment of the present disclosure.

FIG. 2 is a graph for analyzing a pattern or trend of the smart factory monitoring system according to one embodiment of the present disclosure.

FIG. 3A is a graph illustrating recording of a current value of Unit F220, FIG. 3B is an enlarged scope graph for a log A value in a bypass process, and FIG. 3C is an enlarged scope graph for a log A value in an SMT process.

### BEST MODE

Hereinafter, exemplary embodiments according to the present disclosure will be described in detail with reference to the accompanying drawings.

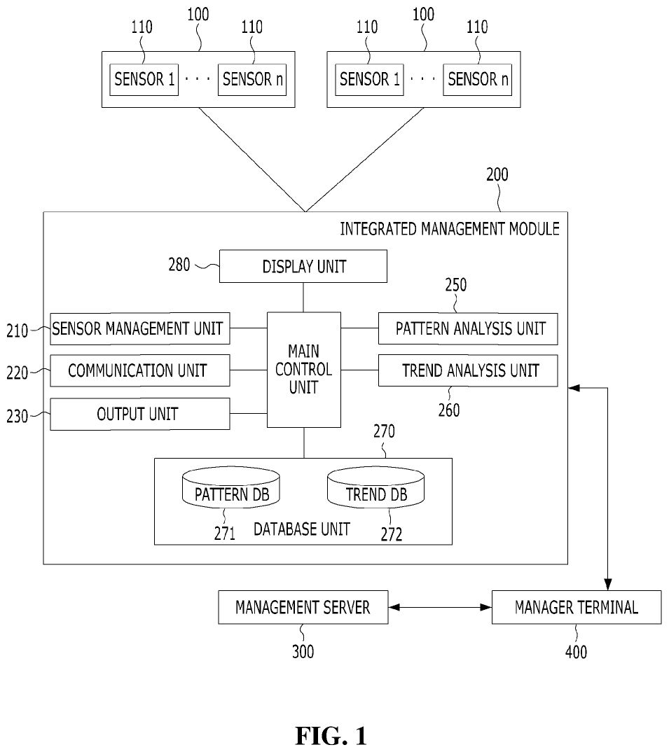

FIG. 1 is a conceptual diagram illustrating a smart factory monitoring system according to one embodiment of the present disclosure.

The smart factory monitoring system manages facilities installed at factories in industrial sites. For example, the smart factory monitoring system may manage industrial facilities and environments including factory automation facilities, manage industrial facilities and environments including energy facilities such as electricity, gas, solar power, water and sewage, and wind power generation, and manage general-purpose facilities and environments, including buildings and home facilities.

As illustrated in FIG. 1, the smart factory monitoring system according to the present disclosure includes a sensor module 100 including a plurality of sensors 110, an integrated management module 200, a management server 300, and a manager terminal 400.

The sensor 110 is disposed on a surface, inside or around a facility or equipment installed in a factory to detect a facility environment such as a temperature, humidity, a pressure, gas, fire, a subject, a strain, an inclination, and vibrations. The sensor 110 may include various sensors such as a temperature sensor, an illuminance sensor, a humidity sensor, a leak sensor, a vibration sensor, and a geomagnetic sensor. For example, in a case of a leak sensor, a leakage of liquid, gas, or the like is detected at a site where the facility is installed. For example, the leak sensor may be a film type or an intelligent leak sensor.

The sensor 110 transmits sensing data detected in the corresponding space to the integrated management module 200 through short-range wireless communication or wired communication. Since the sensor 110 includes a microprocessor, sensing data may be transmitted wirelessly or wired.

Therefore, the sensor 110 may be referred to as a smart sensor or an Internet of Things (IoT) controller. The microprocessor built into the sensor 110 may include various microprocessors including a simple microprocessor used without power (Passive RFID), a powerful central processing unit (CPU) (for example, quad core) having a plurality of cores, or the like depending on the purpose.

The sensor module 100 including the plurality of sensors 110 is configured so that a plurality of other sensors having different communication protocols are mounted, and the communication protocol of each sensor data detected through the mounted sensors is converted into an integrated protocol and transmitted to the integrated management module 200. In this case, the sensor 110 may be connected to the sensor module 100 in a contact or non-contact manner.

A plurality of sensor modules 100 may be installed in the field to form a sensor network, and an application capable of individually or integrally controlling the connected sensors and facilities may be stored.

The sensor module 100 has a structure in which sensors and facilities may be replaced or added in the form of a plug, and automatically recognizes the sensors or facilities when the sensor or facility is replaced or added. In this case, the sensor mounted on the sensor module 100 may be a sensor, but may not be a sensor. For example, the sensor may be a temperature sensor which is attached to various types of facilities installed in a factory to sense a temperature of each facility, a pressure sensor which senses a pressure, a vibration sensor which senses vibrations of the facility, an illuminance sensor which senses illuminance, a leak sensor which senses leakage, or the like.

In addition, the sensor module 100 is configured to be capable of supplying power or battery power.

In addition, the sensor module 100 has a structure in which at least one sensor and a communication unit are combined into one, and transmits sensor data measured through the sensor to the integrated management module 200. Accordingly, the sensor module 100 may transmit sensing data sensed by the plurality of mounted sensors to the integrated management module 200, and the integrated management module 200 may drive a sensor-interlocking application program related to the received sensing data to control the operation of each sensor and may perform warning with respect to an operation state of each sensor and a state of a detection object in various ways by expressing a screen color of a display in red or various colors or by sound through a speaker (not illustrated) using the program.

In addition, the sensor module 100 may have a structure in which at least one actuator and the communication unit are combined and control the corresponding actuator (for example, window control, fan control, water spray control, sun protection control, artificial lighting control, air composition ratio adjustment control, water composition ratio adjustment control, sound control, heating control, cooling control, or the like) according to a message (that is, control signal) received from the integrated management module 200.

In addition, the sensor module 100 may be controlled through a pre-stored algorithm and controlled (remote control or manual control) by an administrator in preparation for an emergency situation such as network disconnection (that is, communication disconnection) with the integrated management module 200.

In addition, the sensor module 100 continuously stores and maintains its own state and a state of the connected sensor in an internal memory (not illustrated) in preparation for maintenance.

The sensor module 100 may collect information on the corresponding facility managed by the sensor module 100 through an interface through a communication line or a power line. Here, it is described as collecting status information of the facility through the sensor module 100, but it is also possible to directly receive the status information obtained from a sensor separately installed in the facility.

Since the above-described sensor module 100 has a function to analyze the sensing data of various types of sensors, the sensor module 100 may provide a solution which can be used inexpensively and simply in industrial sites, advertisement markets, medical fields, education fields, homes, and sites requiring disaster prevention.

That is, at home, the sensor module may be used to monitor and alarm fire, detect and alarm gas leakage, notify temperature/humidity, monitor the inside from outside, or the like, may be applied to a system that recognizes object access, monitors impact, detects glass breakage, monitors an intruder, and recognizes and reports material (paper, water, iron, wood, or the like) in industrial/public sites, or in the field of advertising, may be applied to an interactive touch function and a sensor-interlocking type operation system operated when a user approaches to change a sound and a display screen color and build an advertisement system easily and inexpensively.

The present disclosure provides a sensor data packet format for efficiently transmitting and receiving sensor data between the sensor 110 and the sensor module 100 in order to provide various IoT services, and provides a data transmission/reception procedure and method using the same. Accordingly, the sensor module 100 may automatically recognize the sensor 110 connected to the sensor module 100 to control and manage the sensor, and provide the type and management information of the sensor to the user.

The integrated management module 200 manages and controls a pre-allocated sensor module 100 and the sensors 110 included in the sensor module 100. In this case, it is considered that the sensor module 100 allocated by the integrated management module 200 and the sensors 110 included in the sensor module 100 are installed in the same building.

That is, the integrated management module 200 may monitor facility and environment information from the sensor modules and sensors inside the site, and perform facility and environment control.

The integrated management module 200 supports registration and management of a plurality of sensor modules 100, and receives sensor data from the plurality of sensor modules 100 through an integrated protocol.

The integrated management module 200 controls the operation of the sensor module 100 or facility by receiving a control command from a manager. An identification (ID) is assigned to each of the facilities connected to the plurality of sensor modules 100, and sensor data converted into an integrated protocol from the plurality of sensor modules 100 is received and stored.

The integrated management module 200 may provide information collected in real time and a monitoring result according to information analysis. For example, the integrated management module 200 may output information on facilities collected in real time and a monitoring result obtained by analyzing the collected sensing data.

In addition, the integrated management module 200 may analyze real-time data to predict a failure of a facility or device in advance.

In addition, the integrated management module 200 receives sensing data converted into an integrated protocol from the sensor module 100, analyzes the sensing data to determine abnormal signs in each facility environment, and controls of driving of the facility determined as an abnormal symptom. In addition, when sensing data is received from the sensor, the integrated management module 200 may convert a communication protocol of the sensing data into an integrated protocol, and analyze the converted sensing data to determine abnormal signs in each facility environment.

In addition, the integrated management module 200 may display warnings such as an alarm message, a buzzer, and a tower lamp when determining the abnormal signs. For example, when leak detection information is greater than or equal to a preset reference value, the integrated management module may determine that a leak has occurred at the location of the corresponding sensor and may display a warning message such as an alarm message, a buzzer, and a tower lamp.

In addition, the integrated management module 200 manages management information such as a topology configuration method of a wireless sensor network described in a preset configuration policy, a location of a wireless sensor network, a policy ID of a selected configuration policy, a wireless channel number, a frequency band, location coordinates of the wireless sensor network, and a range of the wireless sensor network, through a management table.

In addition, when the integrated management module 200 receives measurement values from the sensor modules and sensors, the integrated management module 200 analyzes the transmitted measurement values to determine whether there is a failure, and when it is determined that a failure has occurred, the integrated management module 200 transmits a reset command to the corresponding sensor module 100 or the sensor 110. In this case, the measurement value is defined as data capable of determining whether a failure has occurred in the sensor module 100 and the sensor 110, such as an output current, an output voltage, and ping data.

The sensor module 100 or the sensor 110, which has received the reset command from the integrated management module 200, resets (reboots) itself to quickly resolve a failure due to a temporary load.

In addition, the integrated management module 200 may store sensing information received from a plurality of sensors or sensor modules and an analysis result thereof in a DB server through a communication network. In this case, the integrated management module 200 may convert a format such as sensor information, sensing data, and a sensing data analysis result into a predetermined format and store the converted format in the DB server. For example, the integrated management module 200 may be stored as poor obfuscation implementation (POI).

For example, the integrated management module 200 may analyze a digital signal received from the sensor module 100 to determine whether there is a leak in a corresponding site or detect a location of the leak.

The integrated management module 200 connects a sensor network to the plurality of sensors or the plurality of sensor modules through a multi-channel short-range wireless communication while forming the sensor network with the plurality of sensors or the plurality of sensor modules, transmits faulty diagnosis check data of a field facility, battery check data, and an event signal of a field facility to the manager at the corresponding site, and intelligently provides an IoT environment suitable for the situation of the field facility.

More specifically, the integrated management module 200 includes a sensor management unit 210, a communication unit 220, an output unit 230, a main control unit 240, a pattern analysis unit 250, a trend analysis unit 260, a database unit 270, and a display unit 280.

The sensor management unit 210 may periodically search for the plurality of sensors 110 installed in an industrial site and the sensors installed in a facility to obtain information on at least one of whether or not the detected sensor is operated and a usage authority.

In addition, the sensor management unit 210 may control at least one of an operation and a security state of the sensor based on the obtained information.

For example, when the sensor management unit 210 obtains information that the searched sensor 110 does not operate or malfunctions, the sensor management unit 210 transmits a signal for initializing settings of the plurality of sensors installed at the corresponding site and the sensors mounted at the plurality of facilities to the sensor module 100.

Accordingly, it is possible to prevent a case in which a dangerous situation occurs in a situation in which the sensor is turned off and the risk situation cannot be recognized in a timely manner. In addition, when accurate sensing of a dangerous situation is not performed, by setting to be set to an initial state, the sensor may perform correct sensing.

The sensor management unit 210 continuously updates information on identity of the sensor to perform functions such as entity authentication or data integrity, whereby it is possible to prevent a user or device from attempting to connect with malicious intent.

The communication unit 220 receives sensor data from the sensor module 100 or the plurality of sensors 110. The communication unit 220 is connected to the sensor module 100 through short-range wireless communication or wired communication, and receives the sensor data of the sensors 110 included in the sensor module 100.

In addition, the communication unit 220 is connected to the management server 300 or the manager terminal 400 to transmit the data analyzed by the integrated management module 200 thereto.

The output unit 230 outputs information on occurrence of abnormal signs in the event of abnormal signs in the facility environment so that a site manager may recognize the information through at least one of a text, a sound, a lamp, and a fire extinguisher operation.

The output unit 230 may output a text or video through the display unit 280 and output an emergency bell or an emergency light through a speaker or lamp, which is not illustrated.

Meanwhile, when there is no person at the site when there is an abnormality in the facility environment, it may be transmitted to the manager terminal 400, such as a mobile phone or tablet PC, possessed by the manager through the communication unit 220.

The pattern analysis unit 250 analyzes patterns of sensors requiring pattern analysis among the sensors 110 of the sensor module 100 connected to the sensor management unit 210, and compares the patterns of the sensors with pattern information previously stored in a pattern DB 271 of the database unit 270 to determine abnormal signs of the equipment in which the sensor is installed.

More specifically, the pattern analysis unit 250 detects a pattern of a sensor that detects a specific pattern among a plurality of sensors 110 included in the sensor module 100, and determines the abnormal signs when the detected pattern is different from the previously stored pattern information.

For reference, the following examples describe pattern and trend analysis based on F219 equipment and F220 equipment used in the Icheon Hynix semiconductor PKG process.

For example, when assuming that there is an offset operation because rails before and after the step motor are not aligned due to a specific operation process so that a step motor current is not supplied less than 1 second, when the current value is measured one by one in the unit of 1 second in a log file, the current sensor of the sensors 110 measures the current value applied once per second and stores the pattern in the pattern DB 271.

Thereafter, the pattern analysis unit 250 compares and analyzes the pattern of the current measured by the current sensor with the pattern of the current stored in the pattern DB 271.

As a result of the pattern analysis by the pattern analysis unit 250, the main control unit 240 issues warning when a discrepancy rate between the pattern of the current measured by the current sensor and the pattern of the current stored in the pattern DB 271 is 5% or more and 10% or less, issues alarm when the discrepancy rate is 10% or more and 20% or less, and stops the operation of the equipment on which the sensor is mounted when the discrepancy rate is 20% or more.

The pattern analysis unit 250 analyzes patterns of sensors requiring pattern analysis among the sensors 110 of the sensor module 100 connected to the sensor management unit 210, and compares the patterns of the sensors with the pattern information previously stored in the pattern DB 271 of the database unit 270 to determine the abnormal signs of the equipment in which the sensor is installed.

Meanwhile, the trend analysis unit 260 detects a trend of a sensor that detects a specific trend among the plurality of sensors 110 included in the sensor module 100 and determines abnormal signs when the detected trend is different from previously-stored trend information.

For example, it is divided into a case where SMT is performed in Unit F219 and a case not in the specific operation process, and the current value may or may not be regular due to different operations in these cases. When the SMT is performed in the Unit F219, the trend analysis unit 260 analyzes the trend as a distribution of current values being very dense, and when the SMT is not performed in the Unit F219, the trend analysis unit 260 bypasses only the PCB to analyze the trend as the distribution of the current value appearing wider and stores the analyzed trend in the trend DB 272.

Thereafter, the trend analysis unit 260 compares and analyzes the trend of the current measured by the current sensor and the trend of the current stored in the trend DB 272.

As a result of the trend analysis by the trend analysis unit 260, the main control unit 240 issues warning when a discrepancy rate between the pattern of the current measured by the current sensor and the trend of the current stored in the trend DB 272 is 5% or more and 10% or less, issues alarm when the discrepancy rate is 10% or more and 20% or less, and stops the operation of the equipment on which the sensor is mounted when the discrepancy rate is 20% or more.

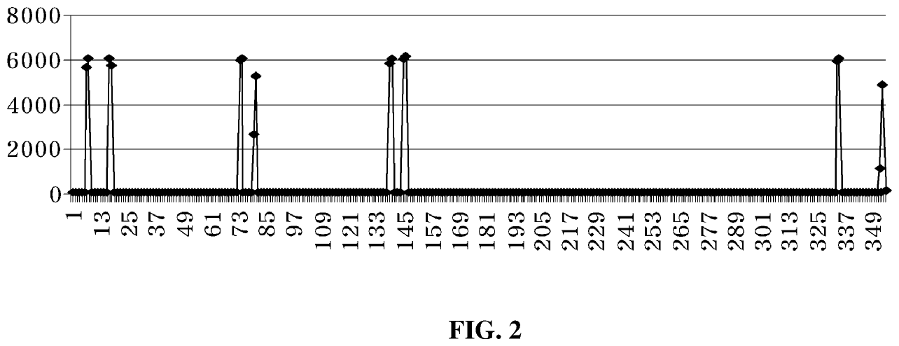

In addition, as illustrated in FIG. 2, according to the analysis result of the pattern analysis unit 250 or the trend analysis unit 260, the main control unit 240 determines that there is a problem in the trend because one-time operation of the step motor is performed within about 1.5 to 1.8 seconds and the operation is regular, but the data cannot be kept to be constant, and thus, issues waring or alarm, or stops the operation of equipment.

The pattern and trend analysis of the operation of the F220 equipment used in a semiconductor PKG process will be described.

The pattern analysis unit 250 detects a pattern of a sensor that detects a specific pattern among a plurality of sensors 110 included in the sensor module 100 and determines abnormal signs when the detected pattern is different from the previously stored pattern information.

For example, when the current is supplied irregularly less than 1 second in order to correct to the misaligned position in a case where the position of the step motor is misaligned in a specific operation process, in the case where the current value is measured one by one in the unit of 1 second in the log file, the current sensor of the sensors 110 measures the current value applied once per second and stores the pattern in the pattern DB 271.

Thereafter, the pattern analysis unit 250 compares and analyzes the pattern of the current measured by the current sensor and the pattern of the current stored in the pattern DB 271.

As a result of the pattern analysis by the pattern analysis unit 250, the main control unit 240 issues warning when a discrepancy rate between the pattern of the current measured by the current sensor and the pattern of the current stored in the pattern DB 271 is 5% or more and 10% or less, issues alarm when the discrepancy rate is 10% or more and 20% or less, and stops the operation of the equipment on which the sensor is mounted when the discrepancy rate is 20% or more.

The pattern analysis unit 250 analyzes patterns of sensors requiring pattern analysis among the sensors 110 of the sensor module 100 connected to the sensor management unit 210, and compares the patterns of the sensors with the pattern information previously stored in the pattern DB 271 of the database unit 270 to determine the abnormal signs of the equipment in which the sensor is installed.

Meanwhile, the trend analysis unit 260 detects a trend of a sensor that detects a specific trend among the plurality of sensors 110 included in the sensor module 100 and determines abnormal signs when the detected trend is different from previously-stored trend information.

For example, the operation of the step motor is divided into a case where SMT is performed in the Unit F219 and a case not in the process, and the current value may or may not be regular due to different operations in these cases. When the SMT is performed in the Unit F219, the trend analysis unit 260 bypasses only the PCB to analyze the trend as the distribution of the current value appearing wider, and when the SMT is not performed in the Unit F219, the trend analysis unit 260 performs the SMT in Unit F220 to analyze the trend as a distribution of current values being very dense and store the analyzed trend in the trend DB 272.

Thereafter, the trend analysis unit 260 compares and analyzes the trend of the current measured by the current sensor and the trend of the current stored in the trend DB 272.

As a result of the trend analysis by the trend analysis unit 260, the main control unit 240 issues warning when a discrepancy rate between the pattern of the current measured by the current sensor and the trend of the current stored in the trend DB 272 is 5% or more and 10% or less, issues alarm when the discrepancy rate is 10% or more and 20% or less, and stops the operation of the equipment on which the sensor is mounted when the discrepancy rate is 20% or more.

In addition, as illustrated in FIG. 2, according to the analysis result of the pattern analysis unit 250 or the trend analysis unit 260, the main control unit 240 determines that there is a problem in the trend because one-time operation of the step motor is performed within about 1.5 to 1.8 seconds and the operation is regular, but the data cannot be kept to be constant, and thus, issues waring or alarm, or stops the operation of equipment.

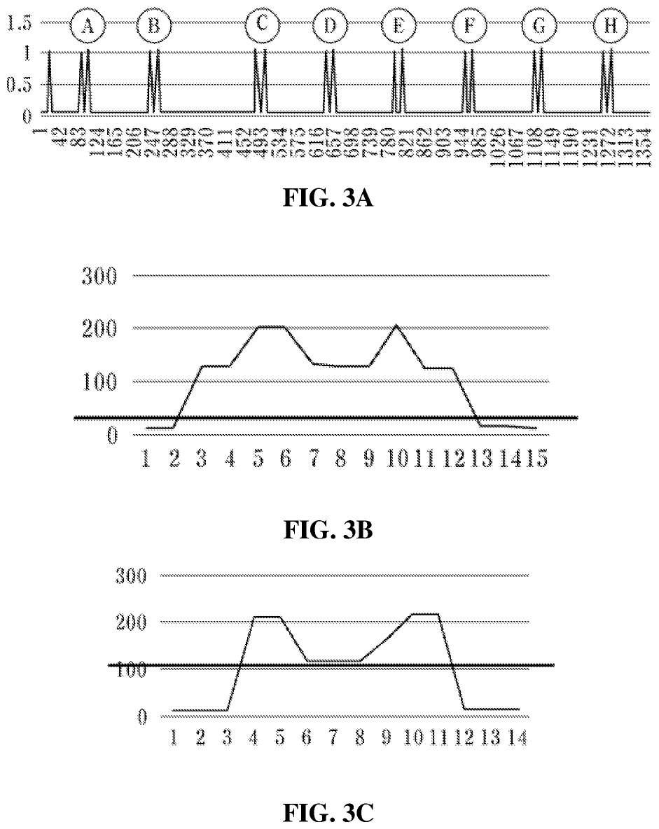

FIG. 3A is a graph illustrating recording of the current value of the Unit F220, FIG. 3B is an enlarged scope graph for a log A value in a bypass process, and FIG. 3C is an enlarged scope graph for the log A value in the SMT process.

As illustrated in FIG. 3B, the main control unit 240 trends a minimum value of the current for the bypass process to 130, a maximum value thereof to 200, and an average value thereof to 152.1 at the A log value according to the analysis result of the trend analysis unit 260, and stores the trended values in the trend DB 272.

Thereafter, when the trend deviates from the trends of the minimum value, the maximum value, or the average value according to the current value in the bypass process measured by the current sensor, the main control unit 240 determines that there is a problem in the trend, and thus, issues waring or abnormality alarm to the facility to which the current sensor is attached or stops the operation of the facility.

In addition, as illustrated in FIG. 3C, the main control unit 240 trends a minimum value of the current for the SMT process to 120, a maximum value thereof to 210, and an average value thereof to 173.25 at the A log value according to the analysis result of the trend analysis unit 260, and stores the trended values in the trend DB 272.

Thereafter, when the trend deviates from the trends of the minimum value, the maximum value, or the average value according to the current value in the SMT process measured by the current sensor, the main control unit 240 determines that there is a problem in the trend, and thus, issues waring or abnormality alarm to the facility to which the current sensor is attached or stops the operation of the facility.

Detailed descriptions of log B to log H of FIG. 3A are the same as those of the log A, and thus, will be omitted.

As described above, it is possible to analyze the trend whether the current value measured by the current sensor is narrowly distributed or widely distributed according to its own size distribution, and it is possible to analyze the pattern in which current distribution of a certain size is performed in a specific period by combining with a time variable.

The present disclosure is not limited to this, a temperature sensor, a pressure sensor, a vibration sensor, an illuminance sensor, a leak sensor, or the like may be previously stored in the pattern DB 271 and the trend DB 272, and thus, the pattern or the trend analysis can be performed by the pattern analysis unit 250 and the trend analysis unit 260.

The integrated management module 200 is connected to the sensor module 100 to directly store and manage the analyzed data and transmit the analyzed data to the manager terminal 400 for monitoring. However, the integrated management module 200 may separately transmit the analyzed data to the external management server 300 to provide the analyzed data to the manager terminal 400 connected to the server at the management server 300.

Although the preferred embodiments according to the present disclosure are described above, various modifications are possible, and those of ordinary skill in the art can make various modifications and corrections without departing from a scope of claims of the present disclosure.

1. A smart factory monitoring system comprising:
a sensor module including a plurality of sensors mounted on various facilities of a factory to detect different physical properties and converting communication protocols of a plurality of sensor data into an integrated protocol;
an integrated management module integrating and managing data measured by the sensor including the plurality of sensor modules through a pattern or trend analysis;
a management server backing up and managing data on the pattern or trend analyzed by the integrated management module and providing the data according to a request of an external device; and
a manager terminal connected to the integrated management module or the management server to perform monitoring at a remote location.

2. The smart factory monitoring system of claim 1, wherein the integrated management module includes:
a sensor management unit registering and managing the sensor or sensor module;
a communication unit receiving sensor data from the sensor or sensor module or transmitting analyzed data to the management server or manager terminal;
an output unit outputting an abnormality to a facility to which the sensor or sensor module is attached through any one of a text, video, sound, lamp, and fire extinguisher operation when the abnormality is detected according to the sensor data by the sensor or sensor module;
a database unit converting data detected by the sensor or sensor module into a database to manage and store the database;
a pattern analysis unit comparing and analyzing the data measured by the sensor or sensor module and data stored according to a pattern of the database unit;
a trend analysis unit comparing and analyzing the data measured by the sensor or sensor module and data stored according to a trend of the database unit; and
a main control unit controlling an operation of equipment to which the sensor or sensor module is attached when the pattern by the pattern analysis unit is deviated from the trend by the trend analysis unit.

3. The smart factory monitoring system of claim 2, wherein the database unit includes:
a pattern DB in which a time variable is combined to a measurement value measured by the sensor or sensor module and a distribution of the measurement values is stored at a specific period; and
a trend DB in which only the distribution of the measurement values measured by the sensor or sensor module is stored.

4. The smart factory monitoring system of claim 3, wherein the main control unit outputs a signal of any one of waring, alarm, and operation stopping of equipment according to a concordance ratio between the value measured by the sensor or sensor module and a pattern data value stored in the pattern DB, as a result of the pattern analysis of the pattern analysis unit.

5. The smart factory monitoring system of claim 4, wherein the main control unit outputs the signal of any one of the waring, alarm, and operation stopping of the equipment according to a concordance ratio between the value measured by the sensor or sensor module and a trend data value stored in the trend DB, as a result of the trend analysis of the trend analysis unit.
